(19) United States
(12) Patent Application Publication
(10) Pub. No.: US 2008/0116957 A1
(43) Pub. Date: May 22, 2008

(54) Circuit for initializing voltage pump and voltage pumping device using the same

(75) Inventor: Jae Boum Park, Seoul (KR)

Correspondence Address: COOPER & DUNHAM, LLP, 1185 AVENUE OF THE AMERICAS, NEW YORK, NY, 10036, US

(73) Assignee: Hynix Semiconductor Inc.

(21) Appl. No.: 11/726,942

(22) Filed: Mar. 22, 2007

(30) Foreign Application Priority Data
Nov. 20, 2006 (KR) 10-2006-0114743

(51) Int. Cl. G05F 3/02

(52) U.S. Cl. 327/536

(57) ABSTRACT

A voltage pump initialization circuit is provided. The voltage pump initialization circuit includes an initialization signal generator for generating an initialization signal which is activated in response to a power-up signal, and an initializer for initializing a voltage pump in response to the initialization signal.

### BACKGROUND

The present disclosure relates to a voltage pumping device, and more particularly to a voltage pumping device capable of preventing a reduction in pumping efficiency.

Generally, a semiconductor device uses a voltage pumping device, to apply a back bias voltage to a certain portion of the semiconductor device, in particular, a cell transistor. Here, “back bias voltage” means a negative voltage generated by negatively pumping an external voltage VDD, to be used for well bias of a memory core region.

Recently, much effort has been conducted in semiconductor device fields, in order to achieve various improvements for reduction of power consumption. In particular, various research has been conducted to reduce power consumption in a self-refresh mode of a DRAM semiconductor device. The current consumed for a self-refresh time to store data in a memory cell during a self-refresh operation is referred to as “self-refresh current”. In order to reduce the self-refresh current, it is necessary to increase the self-refresh period. This may be achieved by increasing the time, for which the memory cell sustains data, namely, a data retention time. One method for increasing the data retention time is to increase the back-bias voltage applied to the transistor of each memory cell. In accordance with this method, the back-bias voltage VBB output from a voltage pumping device after being pumped is supplied to each cell transistor at an increased level in a self-refresh mode, as compared to those in other modes. Accordingly, the off leakage current of the cell transistor can be reduced, so that the data retention time can be increased.

Pump circuits, which are generally used to pump the back-bias voltage VBB, are of a doubler type in which four pump-driving control signals are input to four boot nodes, respectively. In such a doubler type pump circuit, however, the operation for pumping the back-bias voltage VBB may be abnormally carried out when power ON/OFF operations are repeated at a low temperature (or a low VCC level). This is because charge is stored in the boot nodes. This will be described in detail. When the boot nodes are charged in accordance with first power ON/OFF operations, they have a voltage level of about −3V. When a second power ON operation is carried out, there is a phenomenon that the back-bias voltage VBB pumped by the pump circuit is increased in level due to the charge stored in the boot nodes. Such a level increase in the back-bias voltage VBB causes an increase in consumption of current ICC2P, ICC3P, and ICC6. As a result, the power consumption of the pump circuit is increased, thereby causing a reduction in the pumping efficiency of the pumping circuit.

### BRIEF SUMMARY

In one aspect of the present disclosure, a voltage pump initialization circuit comprises an initialization signal generator for generating an initialization signal which is activated in response to a power-up signal and an initializer for initializing a voltage pump in response to the initialization signal.

The initialization signal generator may receive voltages of first and second levels, and may output, as the initialization signal, a signal swung between the first and second levels in response to the power-up signal.

The initialization signal generator may comprise a first pull-up device connected between a terminal for supplying the first-level voltage and a first node, and configured to pull up the first node to the first level in response to the power-up signal, a second pull-up device connected between the first-level voltage supply terminal and a second node, from which the initialization signal is output, and configured to pull up the second node to the first level in response to the power-up signal, a first pull-down device connected between the first node and a terminal for supplying the second-level voltage, and configured to pull down the first node to the second level in response to the signal from the second node, and a second pull-down device connected to the second node and the second-level voltage supply terminal, and configured to pull down the second node to the second level in response to a signal from the first node.

The voltage pump may comprise first to fourth driving devices for driving potentials of first to fourth nodes to predetermined levels in response to first to fourth pump-driving control signals, respectively, a first pull-up device connected between a terminal for supplying the first-level voltage and the first node, and configured to pull up the first node to the first level in response to a signal from the second node, a second pull-up device connected between the first-level voltage supply terminal and the third node, and configured to pull up the third node to the first level in response to a signal from the fourth node, a first pull-down device connected between a terminal for supplying the second-level voltage and the first node, and configured to pull down the first node to the second level in response to a signal from the third node, and a second pull-down device connected to the second-level voltage supply terminal and the third node, and configured to pull down the third node to the second level in response to a signal from the first node.

The voltage pump may further comprise a third pull-up device connected between the second node and the first-level voltage supply terminal, and configured to pull up the second node in response to the first-level voltage, and a fourth pull-up device connected between the fourth node and the first-level voltage supply terminal, and configured to pull up the fourth node in response to the first-level voltage.

The initializer may comprise a first initializing device connected between the second node and the first-level voltage supply terminal, and configured to initialize the second node to the first level, and a second initializing device connected between the fourth node and the first-level voltage supply terminal, and configured to initialize the fourth node to the first level.

In another aspect of the present disclosure, a voltage pumping device comprises a voltage detector configured to receive a voltage of a first level, which is fed back, and a reference voltage, and generate a voltage pumping enable signal an oscillator for generating a pulse signal in response to the voltage pumping enable signal a pump controller for generating a pump-driving control signal in accordance with the pulse signal a voltage pump for pumping the first-level voltage in accordance with the pump-driving control signal and a voltage pump initializer for initializing the voltage pump in response to a power-up signal.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a block diagram illustrating a configuration of a device for pumping a back-bias voltage (VBB) in accordance with an exemplary embodiment of the present disclosure;

FIG. 2 is a circuit diagram illustrating a voltage pump and a voltage pump initializer according to an exemplary embodiment of the present disclosure; and

FIGS. 3A and 3B illustrate respective linear graphs depicting the waveforms of back-bias voltages VBB pumped through the voltage pumping device according to the illustrated embodiment of the present disclosure (FIG. 3B) and a conventional voltage pumping device (FIG. 3A).

### DETAILED DESCRIPTION OF THE DISCLOSURE

Preferred embodiments of the present disclosure will now be described in detail with reference to the accompanying drawings These embodiments are used only for illustrative purposes, and the present disclosure is not limited thereto.

The present disclosure provides a voltage pump initialization circuit and a voltage pumping device using the same which are capable of preventing an abnormal pumping operation causing an increase in the level of a pumped back-bias voltage VBB by initializing an initial voltage of boot nodes in a voltage pump by a ground voltage VSS. Accordingly, it is possible to remove current consumption factors caused by the abnormal pumping operation, and thus, to achieve a reduction in power consumption. As a result, an increase in pumping efficiency, and thus, an enhancement in device quality, can be achieved.

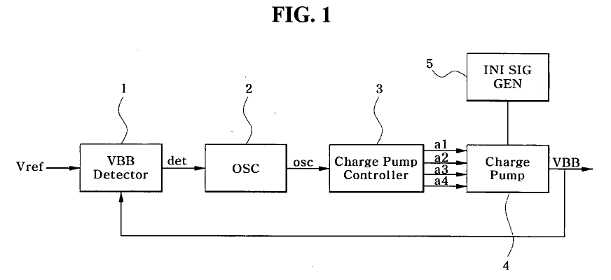

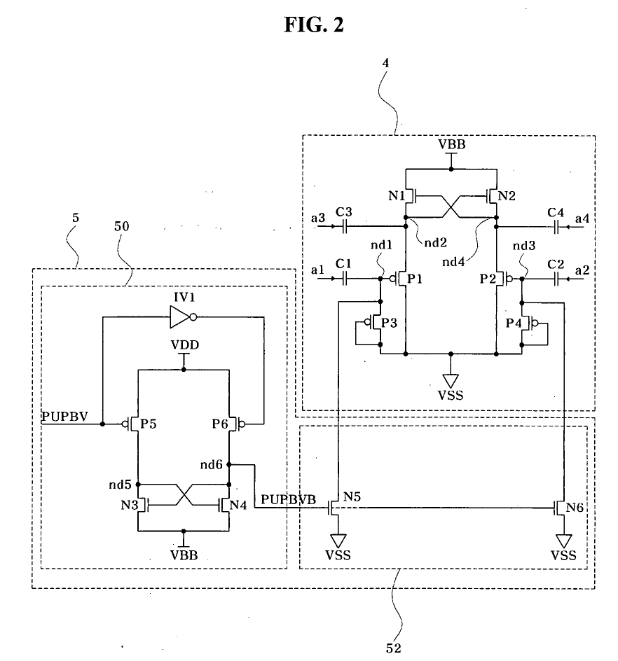

FIG. 1 is a block diagram illustrating a configuration of a device for pumping a back-bias voltage VBB in accordance with an exemplary embodiment of the present disclosure. FIG. 2 is a circuit diagram illustrating a voltage pump and a voltage pump initializer according to an exemplary embodiment of the present disclosure.

As shown in FIG. 1, the back-bias voltage pumping device according to the illustrated embodiment of the present disclosure includes a voltage detector (VBB detector) 1 configured to receive a back-bias voltage VBB fed back thereto and a reference voltage Vref, and generate a voltage pumping enable signal det, an oscillator (OSC) 2 for generating a pulse signal osc in response to the voltage pumping enable signal det, and a pump controller (charge pump controller) 3 for generating pump-driving control signals a1, a2, a3, and a4 in accordance with the pulse signal osc. The back-bias voltage pumping device also includes a voltage pump (charge pump) 4 for pumping the back-bias voltage VBB in accordance with the pump-driving control signals a1, a2, a3, and a4, and a voltage pump initializer (INI SIG GEN) 5 for initializing the voltage pump 4 in response to a power-up signal PUPBV enabled for a power-up period.

As shown in FIG. 2, the voltage pump 4 includes a first capacitor C1 for driving a potential of a node nd1 to a predetermined level in response to the first pump-driving control signal a1, a second capacitor C2 for driving a potential of a node nd3 to a predetermined level in response to the second pump-driving control signal a2, a third capacitor C3 for driving a potential of a node nd2 to a predetermined level in response to the third pump-driving control signal a3, and a fourth capacitor C4 for driving a potential of a node nd4 to a predetermined level in response to the fourth pump-driving control signal a4. The voltage pump 4 also includes a PMOS transistor P1 connected between a ground terminal VSS and the node nd2, and configured to pull up the node nd2 to the level of a voltage at the ground terminal VSS (hereinafter, this voltage is referred to as a “ground voltage VSS”), in response to a signal from the node nd1, a PMOS transistor P2 connected between the ground terminal VSS and the node nd4, and configured to pull up the node nd4 to the level of the ground voltage VSS, in response to a signal from the node nd3, an NMOS transistor N1 connected between a terminal, to which the back-bias voltage VBB is supplied (hereinafter, this terminal is referred to as a “back-bias voltage terminal VBB”), and the node nd2, and configured to pull down the node nd2 to the level of the back-bias voltage VBB in response to a signal from the node nd4, and an NMOS transistor N2 connected between the back-bias voltage terminal VBB and the node nd4, and configured to pull down the node nd4 to the level of the back-bias voltage VBB in response to a signal from the node nd2. The voltage pump further includes a PMOS transistor P3 connected between the ground terminal VSS and the node nd1, and configured to pull up the node nd1 to the level of the ground voltage VSS, in response to the ground voltage VSS, and a PMOS transistor P4 connected between the ground terminal VSS and the node nd3, and configured to pull up the node nd3 to the level of the ground voltage VSS, in response to the ground voltage VSS. Although the present disclosure has been described in conjunction with the embodiment associated with a doubler type voltage pump, it may be applicable to voltage pumping devices of different types for pumping a voltage through boot nodes and capacitors.

The voltage pump initializer 5 includes an initialization signal generator 50 for configured to receive a power-up signal PUPBV, which is enabled for a power-up period, and generate an initialization signal PUPBVB, which is swung between the level of the back-bias voltage VBB and the level of a supply voltage VDD, and an initializer 52 for initializing the voltage pump 4 in response to the initialization signal PUPBVB.

The initialization signal generator 50 includes a PMOS transistor P5 connected between a terminal, to which the supply voltage VDD is supplied (hereinafter, this terminal is referred to as a “supply voltage terminal VDD”), and a node nd5, and configured to pull up the node nd5 to the level of the supply voltage VDD, in response to the power-up signal PUPBV. The initialization signal generator 50 also includes a PMOS transistor P6 connected between the supply voltage terminal VDD and a node nd6, and configured to pull up the node nd6 to the level of the supply voltage VDD, in response to a signal inverted from the power-up signal PUPBV through an inverter IV1, and an NMOS transistor N4 connected between the node nd6 and the back-bias voltage terminal VBB, and configured to pull down the node nd6 to the level of the back-bias voltage VBB.

The initializer 52 includes an NMOS transistor N5 connected between the node nd1 and the ground terminal VSS, and configured to initialize the node nd1 to the level of the ground voltage VSS, and an NMOS transistor N6 connected between the node nd3 and the ground terminal VSS, and configured to initialize the node nd3 to the level of the ground voltage VSS.

The back-bias voltage pumping device having the above-described configuration according to the illustrated embodiment of the present disclosure generates the initialization signal PUPBVB, which is swung between the level of the back-bias voltage VBB and the level of the supply voltage VDD, using the power-up signal PUPBV enabled for the power-up period. Using the generated initialization signal PUPBVB, the back-bias voltage pumping device initializes the nodes nd1 and nd3 to the level of the ground voltage VSS in every power-on operation. Accordingly, it is possible to prevent a phenomenon that the level of the back-bias voltage VBB pumped by the voltage pump 4 is increased due to the charge stored in the nodes nd1 and nd3, even when power ON/OFF operations are repeated at a low temperature (or a low VCC level).

The operation of the back-bias voltage pumping device according to the illustrated embodiment will be described in detail with reference to FIGS. 1 to 3.

The voltage detector 1 receives the back-bias voltage VBB fed back from the voltage pump 4 and the reference voltage Vref, and generates the voltage pumping enable signal det. In response to the voltage pumping enable signal det, the oscillator 2 generates the pulse signal osc. In accordance with the pulse signal osc, the pump controller 3 generates the pump-driving control signals a1, a2, a3, and a4. The voltage pump 4 pumps the back-bias voltage VBB in accordance with the pump-driving control signals a1, a2, a3, and a4. The voltage pump initializer 5 initializes the voltage pump 4 in response to the power-up signal PUPBV which is enabled for a power-up period.

Next, the operation of the voltage pump initializer 5 will be described in detail.

First, the initialization signal generator 50 included in the voltage pump initializer 5 is pulled up to the level of the supply voltage VDD for a power-up period. After termination of the power-up period, the initialization signal generator 50 generates a signal pulled down to the level of the back-bias voltage VBB as the initialization signal PUPBVB. In detail, when the back-bias voltage pumping device is powered on, a power-up period is begun. Accordingly, the power-up signal PUPBV is transited to an enable state, namely, a high-level state. As a result, the PMOS transistor P5 is turned off, whereas the PMOS transistor P6 is turned on. In this state, the initialization signal PUPBVB output from the node nd6 is pulled up to the level of the supply voltage VDD. On the other hand, when the power-up period terminates, the power-up signal PUPBV is transited to a disable state, namely, a low-level state. Accordingly, the PMOS transistor P5 is turned on, whereas the PMOS transistor P6 is turned off. In this state, the node nd5 is pulled up to the level of the supply voltage VDD by the turned-on PMOS transistor P5, thereby causing the NMOS transistor N4 to be turned on. As a result, the initialization signal PUPBVB output from the node nd6 is pulled down to the level of the back-bias voltage VBB.

Thereafter, the initializer 52 included in the voltage pump initializer 5 initializes the nodes nd1 and nd3 to the level of the ground voltage VSS in response to the initialization signal PUPBVB. In detail, the NMOS transistors N5 and N6 are in an ON state for the power-up period because the initialization signal PUPBVB is maintained at the level of the supply voltage VDD for the power-up period. Accordingly, the nodes nd1 and nd3 are initialized to the level of the ground voltage VSS for the power-up period. After termination of the power-up period, the NMOS transistors N5 and N6 are turned off because the initialization signal PUPBVB is transited to the level of the back-bias voltage VBB. As a result, the initialization operations of the nodes nd1 and nd3 are completed.

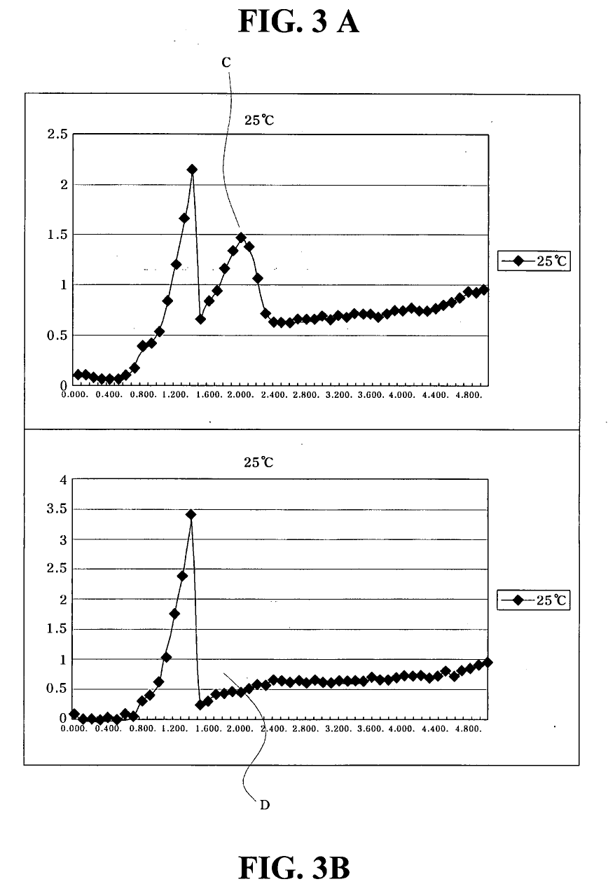

FIGS. 3A and 3B illustrate respective linear graphs depicting the waveforms of back-bias voltages VBB pumped through the voltage pumping device according to the illustrated embodiment of the present disclosure (FIG. 3B) and a conventional voltage pumping device (FIG. 3A). As shown in FIG. 3A, in the operation of the conventional voltage pumping device, the back-bias voltage VBB pumped by the voltage pump 4 is increased in level due to the charge stored in the nodes nd1 and nd3 when power ON/OFF operations are repeated at a low temperature (or a low VCC level), as indicated by a portion C of the graph associated with the conventional voltage pumping device. In the voltage pumping device according to the illustrated embodiment of the present disclosure, there is not an occurrence, however, that the back-bias voltage VBB pumped by the voltage pump 4 is increased in level, because the nodes nd1 and nd3 are initialized to the level of the ground voltage VSS in every power-up period by the voltage pump initializer 5, as indicated by a portion D of the graph (FIG. 3B) associated with the voltage pumping device according to the illustrated embodiment of the present disclosure. Accordingly, in the voltage pumping device according to the illustrated embodiment of the present disclosure, it is possible to remove current consumption factors, and thus achieve an enhancement in device quality.

While preferred embodiments have been described for illustrative purposes herein, those skilled in the art will appreciate that various modifications, additions and substitutions are possible, without departing from the scope and spirit of the disclosure and accompanying claims. For example, elements and/or features of different examples and illustrative embodiments may be combined with each other and/or substituted for each other within the scope of this disclosure and appended claims.

In addition, while preferred embodiments associated with a voltage pumping device for pumping a back-bias voltage VBB have been described, the subject matter of this disclosure may be effectively applied to a voltage pumping device for pumping a high voltage VPP.

The present application claims priority to Korean patent application number 10-2006-114743, filed on Nov. 20, 2006, which is incorporated by reference in its entirety.

What is claimed is:

1. A voltage pump initialization circuit comprising:
an initialization signal generator for generating an initialization signal which is activated in response to a power-up signal; and
an initializer for initializing a voltage pump in response to the initialization signal.

2. The voltage pump initialization circuit according to claim 1, wherein the initialization signal generator receives voltages of first and second levels, and outputs, as the initialization signal, a signal swung between the first and second levels in response to the power-up signal.

3. The voltage pump initialization circuit according to claim 2, wherein the initialization signal generator comprises:
a first pull-up device connected between a first terminal for supplying the first-level voltage and a first node, and configured to pull up the first node to the first level in response to the power-up signal;
a second pull-up device connected between the first terminal and a second node, from which the initialization signal is output, and configured to pull up the second node to the first level in response to the power-up signal;
a first pull-down device connected between the first node and a second terminal for supplying the second-level voltage, and configured to pull down the first node to the second level in response to a signal from the second node; and
a second pull-down device connected to the second node and the second terminal, and configured to pull down the second node to the second level in response to a signal from the first node.

4. The voltage pump initialization circuit according to claim 3, wherein the first level is a supply voltage level.

5. The voltage pump initialization circuit according to claim 3, wherein the second level is a back-bias voltage level.

6. The voltage pump initialization circuit according to claim 3, wherein each of the first and second pull-up devices comprises a PMOS transistor.

7. The voltage pump initialization circuit according to claim 3, wherein each of the first and second pull-down devices comprises an NMOS transistor.

8. The voltage pump initialization circuit according to claim 1, wherein the voltage pump comprises:
first to fourth driving devices for driving potentials of first to fourth nodes to predetermined levels in response to first to fourth pump-driving control signals, respectively;
a first pull-up device connected between a first terminal for supplying the first-level voltage and the first node, and configured to pull up the first node to the first level in response to a signal from the second node;
a second pull-up device connected between the first terminal and the third node, and configured to pull up the third node to the first level in response to a signal from the fourth node;
a first pull-down device connected between a second terminal for supplying the second-level voltage and the first node, and configured to pull down the first node to the second level in response to a signal from the third node; and
a second pull-down device connected to the second terminal and the third node, and configured to pull down the third node to the second level in response to a signal from the first node.

9. The voltage pump initialization circuit according to claim 8, wherein the first level is a ground voltage level.

10. The voltage pump initialization circuit according to claim 8, wherein the second level is a back-bias voltage level.

11. The voltage pump initialization circuit according to claim 8, wherein each of the first and second pull-up devices comprises a PMOS transistor.

12. The voltage pump initialization circuit according to claim 8, wherein each of the first and second pull-down devices comprises an NMOS transistor.

13. The voltage pump initialization circuit according to claim 8, wherein the voltage pump further comprises:
a third pull-up device connected between the second node and the first terminal, and configured to pull up the second node in response to the first-level voltage; and
a fourth pull-up device connected between the fourth node and the first terminal, and configured to pull up the fourth node in response to the first-level voltage.

14. The voltage pump initialization circuit according to claim 13, wherein each of the third and fourth pull-up devices comprises a PMOS transistor.

15. The voltage pump initialization circuit according to claim 8, wherein the initializer comprises:
a first initializing device connected between the second node and the first terminal, and configured to initialize the second node to the first level; and
a second initializing device connected between the fourth node and the first terminal, and configured to initialize the fourth node to the first level.

16. The voltage pump initialization circuit according to claim 15, wherein the first level is a ground voltage level.

17. The voltage pump initialization circuit according to claim 15, wherein each of the first and second initializing devices comprises an NMOS transistor.

18. A voltage pumping device comprising:
a voltage detector configured to receive a voltage of a first level, which is fed back, and a reference voltage, and generate a voltage pumping enable signal;
an oscillator for generating a pulse signal in response to the voltage pumping enable signal;
a pump controller for generating a pump-driving control signal in accordance with the pulse signal;
a voltage pump for pumping the first-level voltage in accordance with the pump-driving control signal; and
a voltage pump initializer for initializing the voltage pump in response to a power-up signal.

19. The voltage pumping device according to claim 18, wherein the voltage pump initializer comprises:
an initialization signal generator for generating an initialization signal which is activated in response to the power-up signal; and
an initializer for initializing a voltage pump in response to the initialization signal.

20. The voltage pumping device according to claim 19, wherein the initialization signal generator receives voltages of first and second levels, and outputs, as the initialization signal, a signal swung between the first and second levels in response to the power-up signal.

21. The voltage pumping device according to claim 19, wherein the initialization signal generator comprises:
a first pull-up device connected between a first terminal for supplying the first-level voltage and a first node, and configured to pull up the first node to the first level in response to the power-up signal;
a second pull-up device connected between the first terminal and a second node, from which the initialization signal is output, and configured to pull up the second node to the first level in response to the power-up signal;
a first pull-down device connected between the first node and a second terminal for supplying the second-level voltage, and configured to pull down the first node to the second level in response to a signal from the second node; and
a second pull-down device connected to the second node and the second terminal, and configured to pull down the second node to the second level in response to a signal from the first node.

22. The voltage pumping device according to claim 21, wherein the first level is a supply voltage level.

23. The voltage pumping device according to claim 21, wherein the second level is a back-bias voltage level.

24. The voltage pumping device according to claim 21, wherein each of the first and second pull-up devices comprises a PMOS transistor.

25. The voltage pumping device according to claim 21, wherein each of the first and second pull-down devices comprises an NMOS transistor.

26. The voltage pumping device according to claim 18, wherein the voltage pump comprises:
first to fourth driving devices for driving potentials of first to fourth nodes to predetermined levels in response to first to fourth pump-driving control signals, respectively;
a first pull-up device connected between a first terminal for supplying the first-level voltage and the first node, and configured to pull up the first node to the first level in response to a signal from the second node;
a second pull-up device connected between the first terminal and the third node, and configured to pull up the third node to the first level in response to a signal from the fourth node;
a first pull-down device connected between a second terminal for supplying the second-level voltage and the first node, and configured to pull down the first node to the second level in response to a signal from the third node; and
a second pull-down device connected to the second terminal and the third node, and configured to pull down the third node to the second level in response to a signal from the first node.

27. The voltage pumping device according to claim 26, wherein the first level is a ground voltage level.

28. The voltage pumping device according to claim 26, wherein the second level is a back-bias voltage level.

29. The voltage pumping device according to claim 26, wherein each of the first and second pull-up devices comprises a PMOS transistor.

30. The voltage pumping device according to claim 26, wherein each of the first and second pull-down devices comprises an NMOS transistor.

31. The voltage pumping device according to claim 26, wherein the voltage pump further comprises:
a third pull-up device connected between the second node and the first terminal, and configured to pull up the second node in response to the first-level voltage; and
a fourth pull-up device connected between the fourth node and the first terminal, and configured to pull up the fourth node in response to the first-level voltage.

32. The voltage pumping device according to claim 31, wherein each of the third and fourth pull-up devices comprises a PMOS transistor.

33. The voltage pumping device according to claim 26, wherein the initializer comprises:
a first initializing device connected between the second node and the first terminal, and configured to initialize the second node to the first level; and
a second initializing device connected between the fourth node and the first terminal, and configured to initialize the fourth node to the first level.

34. The voltage pumping device according to claim 33, wherein the first level is a ground voltage level.

35. The voltage pumping device according to claim 33, wherein each of the first and second initializing devices comprises an NMOS transistor.
